(19) United States
(12) Patent Application Publication
(10) Pub. No.: US 2017/0175385 A1
(43) Pub. Date: Jun. 22, 2017

(54) Moisture-Variable Protective Layer and Use of a Moisture-Variable Protective Layer

(71) Applicants: Heinz-Peter Raidt, Dortmund (DE); Gilles Schwaab, Dortmund (DE); Nicole Höfer, Witten (DE); Jörn Schröer, Herdecke (DE); Ewald Dörken AG, Herdecke (DE)

(72) Inventors: Heinz-Peter Raidt, Dortmund (DE); Gilles Schwaab, Dortmund (DE); Nicole Höfer, Witten (DE); Jörn Schröer, Herdecke (DE)

(73) Assignee: Ewald Dörken AG, Herdecke (DE)

(21) Appl. No.: 15/234,689

(22) PCT Filed: Feb. 10, 2015
(86) PCT No.: PCT/EP2015/000279

§ 371 Date: Aug. 11, 2016

(30) Foreign Application Priority Data
Feb. 13, 2014 (DE) 10 2014 001 919.5
Jun. 16, 2014 (DE) 10 2014 008 530.9

(51) Int. Cl. E04B 1/62; B32B 27/30; B32B 27/34; B32B 27/40; E04D 11/02; E04B 1/64; E04B 1/66; E04D 12/00; E04D 5/06; E04D 5/10; B32B 27/12; B32B 5/02

(52) U.S. Cl. CPC E04B 1/625; B32B 27/12; B32B 27/306; B32B 27/34; B32B 27/40; B32B 5/02; E04B 1/64; E04B 1/665; E04D 12/002; E04D 5/06; E04D 5/10; E04D 11/02; B32B 2262/101; B32B 2307/304; B32B 2307/7246; B32B 2419/06; B32B 2607/02

(57) ABSTRACT

A moisture-variable protective layer is to be used in particular for protecting a thermal insulating layer in insulated building structures, such as roof and/or wall structures of a building. The protective layer has a water vapor diffusion-dependent air layer thickness S_{d} that is dependent on the ambient humidity. The protective layer at least partly consists of and/or comprises a material that has a water vapor diffusion equivalent air layer thickness S_{d} of greater than 10 m at a relative humidity of the atmosphere surrounding the protective layer in the range from 0% to 25% and has a water vapor diffusion equivalent air layer thickness S_{d} of less than 0.4 m at a relative humidity of the atmosphere surrounding the protective layer in the range from 90% to 100%.

### CROSS-REFERENCE TO RELATED APPLICATIONS

This application is the U.S. national stage application of International Application PCT/EP2015/000279, filed Feb. 10, 2014, which international application was published on Aug. 20, 2015, as International Publication WO 2015/120973 in the English language. The International Application claims priority of German Patent Application No. 10 2014 001 919.5, filed Feb. 13, 2014 and German Patent Application No. 10 2014 008 530.9, filed Jun. 16, 2016. The international application and German applications are incorporated herein by reference, in entirety.

### FIELD

The invention relates to a protective layer, in particular for use in protecting a thermal insulation layer in insulated building structures, such as roof and/or wall structures of a building, having a water vapor diffusion equivalent air layer thickness S_{d} which depends on the ambient humidity. Moreover, the present invention relates to the use of a moisture-variable protective layer in an insulated building structure.

### BACKGROUND

For insulated roof and wall structures, diffusion-inhibiting layers are required in order to avoid harmful condensation. Condensation occurs when humid air flows and/or diffuses due to water vapor partial pressure differences in the structure, and the temperature drops below the dew point of the water vapor due to a temperature change.

In winter in central Europe, there is usually a water vapor diffusion flow from the interior of the building to the exterior, because there is a low partial water vapor pressure outside the building due to low temperatures and low humidity. The insulated structure has a temperature gradient from the inside to the outside. Since air can hold less water with decreasing temperature, the dew point may be reached as the temperature in the structure decreases, such that condensation occurs in the structure. In summer, the diffusion flow is usually opposite, but not critical, since the dew point of the water is usually not reached due to higher air temperatures. However, if condensation occurs, it generally evaporates at higher summer air temperatures. However, if more condensation is created than can evaporate, this can also lead to structural damage.

To counter the diffusion flow and the formation of condensation, barrier layers are used. The barrier effect of components or layers with respect to water vapor diffusion is described by the water vapor diffusion equivalent air layer thickness Sd. The greater the S_{d} value is, the less water vapor diffuses through the layer.

Known in the prior art is the protection against condensation on the inner side using exclusively air and vapor barriers with constant, relatively high S_{d} values, intended to inhibit and/or prevent the diffusion of water vapor. On the outside of the heat insulation, diffusion-open materials are used to allow drying out in summer.

Increasingly, sheets and/or protective layers with a moisture-variable S_{d} value are used, which are described for example in WO 96/33321 A1. Such sheets have, in a dry climate with an average relative humidity of 30 to 50%, an S_{d} value from 2 m to 5 m, and in a humid climate with an average relative humidity of 60% to 80%, an S_{d} value of <1 m. The variability of the S_{d} value makes it possible that in a dry environment, such as may occur, for example, indoors in the winter, because of the high barrier effect no moisture can diffuse into the structure, while in the summer potential moisture can diffuse to the outside on account of the reduced barrier effect. The previously described S_{d} value combination delivers good results in temperate climates which are typical for Holzkirchen or Helsinki, as well as in very humid regions that are typical for Miami, for example. However, if it is very cold and damp, or in moist, warm interior conditions, such as in bathrooms, high moisture accumulations can arise on the outside of a thermal insulation, for example in the form of glass wool.

A vapor retarder film based on polyamide as part of an insulated building structure, having a water vapor diffusion resistance dependent on the ambient humidity, is known from EP 1 824 902 B 1. The S_{d} values in this case vary between >5 m at 30% to 50% relative humidity and <0.5 m at 60% to 80% relative humidity. However, the variation range of polyamides is limited; the maximum upper S_{d} values in the dry area are approximately 10 m, and the minimum S_{d} values in the moist area are not significantly below 0.2 m.

Document WO 02/070251 A1 relates to the use of ionomers for sealing insulating materials. lonomers should have, in layer form, at 25% relative humidity, an S_{d} value of 1 m to 20 m, and at 72.5% relative humidity an S_{d} value from 0.02 m to 0.7 m. The production of films using ionomers, however, is complicated and costly. Even an S_{d} value of, for example, 1 m at 25% relative humidity is too low to be able to fulfill a function as an effective protective layer.

A moisture-adaptive protective layer, in particular for use as thermal insulation of buildings, is known from the document WO 2011/069672 A1, wherein the protective layer is formed of a material which, at a humidity of 45% to 58%, moves in a plateau-like manner within a range of S_{d} values from 2 m to 5 m diffusion equivalent air layer thickness. This ensures that upon a use-related short-term increase in humidity, such as in kitchens or swimming pools, an opening of the film does not occur immediately, thereby allowing too much moisture into the structure.

Moisture-variable protective layers can be constructed in single- or multi-layer configurations according to WO 2007/146391 A2, for example as a coating with a wide range of variations in the chemical composition thereof.

All the moisture-adaptive protective layers described above are only used on interior sides. There is therefore the need to use another diffusion-open film on the outside of a thermal insulation in order to allow (summer) dehydration. The selection of appropriate protective layers must also always be carried out under consideration of various climatic conditions, especially hot summers and very cold winters.

The problem addressed by the present invention is that of providing a moisture-adaptive and/or moisture-variable protective layer which has improved properties for the prevention of damage by moisture to the building materials used in the building structure. The protective layer should particularly be suitable for use in insulated roof and/or wall structures of a building, and fulfill an outstanding protective function for a thermal insulation layer of the structure. In particular, the protective layer should be suitable for a virtually global and climate-independent deployment in insulated structures, such that damage to the structure, up to and including the failure of the structure due to moisture accumulation, is not to be anticipated. The protective layer should furthermore be equally suitable for use on the inner side and the outer side in an insulated building structure to protect a thermal insulation layer, and should prevent a failure of the structure due to moisture accumulation.

### SUMMARY

The afore-mentioned problem is solved by a moisture-variable protective coating with the features of claim 1 or 2. Advantageous embodiments are the subject matter of the dependent claims.

According to the invention, a layer is referred to as moisture-variable if the S_{d} value of the layer changes with increasing or decreasing moisture of the air surrounding the protective layer in such a manner that, overall, there is a different structural-physical behavior than there would be if the S_{d} value were constant. This process must be reversible. The change in the structural-physical behavior in this case must be from a more pronounced diffusion-inhibiting to a more pronounced diffusion-open behavior, and vice versa. Basically, the S_{d} value increases with decreasing moisture, or decreases with increasing moisture, respectively. The Sd-value profile as a function of the humidity in this case is non-linear, has at least three curve segments, and contains one or two inflection points. The absolute inflection point, that is, the transition between diffusion-inhibiting and diffusion-open behavior, is between 50 and 90% relative humidity. The S_{d} value can be between 0.05 m and 150 m over the entire moisture range.

For the sake of completeness, it should be noted that the S_{d} value indicates the water vapor diffusion equivalent air layer thickness, which is a measure within the field of building physics for the water vapor diffusion resistance of a component or a component layer. The S_{d} value is given with the unit [m], and is composed physically as the product of a dimensionless material constant, the water vapor diffusion resistance factor μ of the respective building material, multiplied by the component layer thickness “S” given in the unit [m].

The protective layer according to the invention is preferably characterized in that the S_{d} value at a relative humidity of 90% is between 0.05 m and 0.4 m, wherein the S_{d} value is preferably as small as possible. In this case, values of less than 0.1 m, and particularly less than 0.09 m, are preferred.

At a relative humidity of 80%, the S_{d} value of the protective layer according to the invention is preferably between 0.051 m and 150 m, and in any case is always greater than at a relative humidity of 90%, and less than at a relative humidity of 50%.

At a relative humidity of 65.5%, the S_{d} value should be between 4 m and 20 m, preferably between 5 m and 15 m, and in any case greater than at a relative humidity of 80% and less than at a relative humidity of 50%.

At a relative humidity of 50%, the S_{d} value can preferably be between 5 and 150 m, but in any case is always greater than at a relative humidity of 80% and less than at a relative humidity of 25%.

At a relative humidity of 37.5%, the S_{d} value should be between 20 m and 90 m, in particular between 30 m and 80 m, wherein it is always greater than the S_{d} value at a relative humidity of 50% and less than at a relative humidity of 25%.

At a relative humidity of 25%, the S_{d} value of the protective layer according to the invention can be between 10 m and 150 m, and is always greater than at a relative humidity of 50%. Preferably, the S_{d} value at a relative humidity of 25% is between 40 m and 90 m.

In an alternative embodiment, the S_{d} values can be even lower at a relative humidity of 25%. The S_{d} value in this case can be between 10 m and 30 m. Thereafter, the S_{d} value continuously decreases and is, for example at a relative humidity of 37.5%, between 10 m and 30 m, and in any case is less than at a relative humidity of 25%. At a relative humidity of 65.5%, the S_{d} value is preferably less than 10 m; at a relative humidity of 80% it is preferably less than 0.1 m. At a relative humidity of 90%, the S_{d} value is likewise less than 0.1 m, but is still lower than at 80%.

In all embodiments, with increasing relative humidity the S_{d} value always decreases.

Also, it should be noted that in the aforementioned intervals of S_{d} values, where the individual values of the relative humidity are given, all intermediate intervals and also all individual values should be considered disclosed and essential to the invention, even if they are not specified in detail.

Also, it should be understood that the S_{d} value ranges named above for different humidities need not be met cumulatively in all cases by the protective layer according to the invention. What is essential is that the protective layer according to the invention, at a relative humidity of the atmosphere surrounding the protective layer in the range of 0% to 25%, has an S_{d} value of greater than 10 m, and at a relative humidity in the range of 90% to 100% has an S_{d} value of less than 0.4 m. The following combinations of S_{d} value ranges are given as examples for the given humidities according to the invention:

| | Humidity [%] | | | |
|---|---|---|---|---|
| | 25 | 50 | 80 | 90 |
| S_{d} value [m] | 10 | 5 | 0.11 | 0.05 |
| S_{d} value [m] | 10 | 8.8 | 0.051 | 0.05 |
| S_{d} value [m] | 10 | 9.999 | 9.998 | 0.4 |

In the range of a relative humidity of less than 25%, the S_{d} value of the protective layer is below the S_{d} value range which, for a relative humidity of 25%, is provided according to the invention. In other words, the S_{d} value in the range of a relative humidity of less than 25% is more than 10 m, up to more than 150 m.

The water vapor permeability is tested, and the S_{d} values are measured, in accordance with DIN EN ISO 12572 and DIN EN 1931, according to the range of humidity. The moisture-adaptive behavior of the material of the protective layer can be influenced by ab- or adsorptive processes, swelling, other physical processes and/or by chemical reactions, and/or can be reversible.

Comprehensive hygrothermal simulations carried out in the development of the invention, to evaluate the moisture-proofness of insulated building structures, wherein the calculations were performed using the WUFI®, 5.2 method developed at the Fraunhofer Institute for Building Physics for calculating the transient heat and moisture transport in building components, as well as comprehensive experiments carried out in the development of the invention, have shown that protective layers with the water vapor diffusion characteristics described above have significantly improved properties to prevent damage to the construction materials due to moisture. The high S_{d} values at low humidities particularly rule out a dangerous formation of condensation in the insulated structure when there is a water vapor diffusion flow from inside to outside in the European winter. At high humidities, however, the S_{d} value of the protective layer is minimized in order to facilitate the escape of water vapor from the structure. This makes it possible to reduce potential condensation amounts, and to increase dehydration reserves.

The protective layer according to the invention can be advantageously used in insulated building structures, particularly insulated roof and/or wall structures of a building, for protecting a thermal insulation layer of the building structure. At least one protective layer can be provided on an outer side of thermal insulation layer, particularly following after a building roof made of roof tiles, roof shingles, or another roofing material, or following after a facade sheathing of stone, wood, or another facade material of a rear-ventilated facade, and also on an inner side of thermal insulation layer which faces an interior of the building, particularly arranged in front of a cladding following thereafter, formed by gypsum plasterboard or the like. It is further preferred that a protective layer is arranged on the inner side, and another on the outer side, in particular directly on the thermal insulation layer.

The protective layer according to the invention can be used virtually worldwide and independent of climate. The S_{d} values profile of the protective layer according to the invention makes the use of different protective layers on the inner side and the outer side unnecessary. In an insulated building structure, the protective layer can help to prevent the failure of the structure due to moisture accumulation.

The S_{d} values profile of the protective layer according to the invention makes it possible to achieve safe moisture contents for the most diverse climates in insulated building structures, particularly if the water vapor diffusion equivalent air layer thickness S_{d} of the protective layer arranged on the inner side of the thermal insulation layer and of the protective layer arranged on the outer side of the thermal insulation layer differ from each other by less than 20%, preferably less than 10%, in the range of a relative humidity from 0% to 25%, and/or from 80% to 100%, preferably from 85% to 100%. The difference between the S_{d} values of both protective layers can also be less than 5% in the ranges named above. Protective layers are used according to the invention on the outside and on the inside of thermal insulation layers which have a very similar or substantially the same S_{d} value profile. Also, in the range of a relative humidity of 25% to 50%, and/or 50% to 80%, preferably from 50% to 85%, the difference in the water vapor diffusion equivalent air layer thicknesses S_{d} of both protective layers can be in the aforementioned ranges. The term “S_{d} value profile” in this case relates to the dependence of the water vapor diffusion equivalent air layer thickness S_{d} of the diffusion-inhibiting material of the protective layer on the relative humidity of the atmosphere surrounding the protective layer.

In one preferred use of the protective layer according to the invention in an insulated building structure, protective layers are used on the inside and on the outside of thermal insulation layer, having the same water vapor diffusion equivalent air layer thickness S_{d}, which is dependent on the ambient humidity, in the range of a relative humidity of 0% to 25%, and/or in the range of a relative humidity of 80% to the 100%, preferably from 85% to 100%. More preferably, in this context, protective layers having the same design and/or being the same are used on the inner side and the outer side of the thermal insulation layer. This leads to a simple construction of the structure and ensures that the building structure according to the invention can be advantageously used in almost all climates.

The invention is particularly based on the idea of enabling a construction of the building structure which is independent of climate, by using a special moisture-variable protective layer with an increased barrier value in dry environments and a very low barrier value at very high humidity both on the outside and on the inside of an insulated building structure. This obviates the hitherto existing need to use different films for creating the insulation structure. Also, it is no longer necessary to take into account diverse climate conditions, especially hot summers and very cold winters, by using different films.

A feature of the protective layer is preferably that the moisture-variable material can form an airtight layer to conserve energy and protect wood. The airtightness of multiple protective layers in connection with each other can be established using self-adhesive strips, welding, adhesive tapes, or suitable adhesives. Air-tightness is necessary, but only for the protective layer as a whole. In a multilayer structure, it is not necessary for all of the layers to be airtight individually. The protective layer can be bonded to building parts with suitable adhesives and/or Compriband with batten fixation.

The moisture-variable material can be designed as a panel and/or flat structure, in particular as a (flexible) film and/or membrane and/or as a coating of a substrate material, more particularly as a brushed-on and/or sprayed coating of a substrate material, and/or can have such a flat structure. The film can be applied as a polymer coating (one or both sides) to a substrate material, or be laminated to a substrate material on one or both sides, wherein the substrate material can particularly be a fabric or a fleece. An adhesive layer can be included to improve the adhesion between the film and the substrate material. In the protective layer according to the invention, the moisture-variable material can also have an adhesive component for improving the adhesion between the film and a substrate material. The protective layer can be equipped with self-adhesive strips or with a full-surface adhesive layer.

The starting materials for the production of the protective layer can be used in the form of plastic granules or dispersions/emulsions and/or powders. The manufacturing process can be based on casting, coagulation, blown film or film extrusion methods. Individual layers can be calendered, laminated, or bonded by means of heat or adhesive layers. Furthermore, dipping, spraying, sputtering, and knife coating are possible for liquid components. A subsequent heat fixation or stretching, or hydrophobization of an intermediate product may be necessary for producing the protective layers.

The protective layer according to the invention preferably has a layer thickness of 10 μm to 3 mm, more preferably from 20 μm to 2 mm, and particularly preferably from 50 μm to 1 mm.

The weight per unit area of the protective layer can be between 20 g/m² and 700 g/m², preferably between 50 g/m² and 270 g/m².

The moisture-variable material can comprise a polyamide (PA), in particular PA 6, PA 3, and/or a polyamide copolymer, and/or can be a material which can be obtained from and/or consists of, polyamide, in particular PA 6, PA 3, and/or a polyamide copolymer, as a starting material, optionally with other components.

To achieve the required characteristics with respect to water vapor diffusion resistance, the material can also comprise an ionomer and/or can be obtained from or consist of an ionomer as the starting material, and optionally further components. It is also possible that the material has an ethylene vinyl alcohol homo- or copolymer (EVAL), and/or can be obtained from, or consists of, the same.

A suitable moisture-variable material can also be polyurethane (PU), particularly a thermoplastic polyurethane (TPU). Preferably, a polyurethane that is obtained by a combination and/or reaction of aliphatic or aromatic diisocyanates with polyester-, polyether-, polyetherester-, polycaprolactam- or polycarbonate-diols can be employed. The material can be designed as a film and/or can have a film, the preparation of which is based on polyurethane and/or consists of polyurethane and/or comprises polyurethane. In particular, a film can be used which is made of thermoplastic polyurethane and/or consists of a thermoplastic polyurethane and/or comprises a thermoplastic polyurethane. The moisture-variable material can also be partly or completely made of a thermoplastic polyester elastomer (TPE-E), known under trade names such Keyflex, Hytrel, Arnitel, or the like, or made of thermoplastic polyamide elastomer (TPE-A), known by way of example under the trade name Pebax or the like.

Alternatively, it is also possible that the diffusion-inhibiting material comprises an ethylene vinyl acetate (EVA) as the starting material and/or can be obtained from or consists of an ethylene-vinyl acetate and optionally other components.

To achieve the required characteristics of the protective layer with respect to water vapor diffusion resistance, a film as the protective layer can preferably be obtainable from or consists of a mixture of a polyurethane with a polymer having vinyl alcohol as the monomer portion, and optionally other components, and/or can consist of such a mixture and/or can comprise such a mixture. Such a polymer containing a vinyl alcohol can be, by way of example, a polymer obtainable under the trade name EVAL from the Kuraray company. EVAL resins offer excellent gas barrier properties and can be processed easily and inexpensively using conventional production equipment. Resins according to the invention have a vinyl alcohol content of 52 wt. % to 76 wt. %, preferably from 60 wt. % to 70 wt. %, and more preferably from 65 wt. % to 68 wt. %. It has proven to be expedient if the polyurethane content in the mixture is more than 50 wt. %, in particular more than 60 wt. %, and more particularly more than 75 wt. %, based in each case on the mixture.

It should be understood that the moisture-variable material can also be obtained from a combination and/or reaction of at least two of the aforementioned starting materials. In particular, the material can be a combination of a component with a high barrier value and a component having a low barrier value, also in combination with other components. The S_{d} values/relative humidity conditions, as well as other properties such as hardness or flexibility, are made specifically adjustable by modifying the weight fractions in this case.

The moisture-variable material can contain active or passive additives and/or fillers. Active additives are understood in the context of the invention as those which affect the moisture variability of the diffusion-inhibiting material by, for example, being able to absorb moisture. For example, the active additive can be a fumed silica, in particular a silica obtainable under the trade name AEROSIL®. Passive fillers, in contrast, within the context of the invention, are those whose properties are moisture independent, such as phyllosilicates for example. Stabilizers or processing aids can be used as further additives.

To further improve or ensure the required characteristics with respect to the water vapor diffusion resistance, a polyurethane and/or an ethylene vinyl alcohol polymer and/or the mixture thereof can have at least one filler as an additive, by way of example, in particular a phyllosilicate, and more specifically a nanophyllosilicate. Phyllosilicates are gas-impermeable plates. They produce a barrier effect against diffusion of gases such as water vapor, because of their orientation in the plastic. Ideally, the nanoclays are oriented in such a manner that they can generate a higher barrier value and thus a higher S_{d} value than the matrix polymer. If a matrix polymer is used, which can swell at elevated moisture, this can lead to the phyllosilicate platelets orienting in such a manner that accelerated vapor transport at the layer boundaries is made possible by the distances between the layers increasing, thereby achieving a very low S_{d} value.

A particularly high level of resistance against undesired penetration of moisture into the structure results if a change in the relative humidity of the atmosphere surrounding the protective layer leads to a delayed change in the water vapor diffusion equivalent air layer thickness S_{d} of the material. If the reaction is delayed, the protective layer is then open and/or has an increased permeability to water vapor if the short-term increase in moisture has already attenuated. This then largely rules out the possibility of an undesired entry of moisture into the insulated building structure. If, in contrast, there is a permanent presence of moisture inside the building and/or the building structure, the moisture can escape as soon as the film is open.

Preferably, the moisture-variable material is designed in such a manner that an increase in the relative humidity, for example from a range between 0% and 25% to a range of 80% to 100%, leads to a lowering of the water vapor diffusion equivalent air layer thickness S_{d} of the material, for example to an S_{d} value of less than 5 m, preferably less than 1 m, and more preferably less than 0.1 m, after 2 h to 96 h, in particular after 12 h to 72 h, and more particularly after 24 h to 28 h. Because the lowering of the S_{d} value occurs with a delay after the increase in moisture, a short-term increase in moisture, as can arise when the building is used, for example as a result of cooking, or even after a rainstorm, does not result in too much water penetrating into the structure. On the other hand, moisture which is present over long periods of time, as can occur in the interior of the structure, can escape.

### BRIEF DESCRIPTION OF THE DRAWINGS

In the Drawings:

FIG. 1 is a graphical profile of S_{d} value vs. relative humidity for one example of a protective layer of an insulated building structure according to the present disclosure.

FIG. 2 is a schematic view of an insulated roof structure having protective layers as profiled in FIG. 1.

FIG. 3 is a schematic view of a layer structure for the roof structure of FIG. 2.

FIG. 4 is a graphical profile of S_{d} value vs. relative humidity for another example of a protective layer.

FIG. 5 is a graphical profile of S_{d} value vs. relative humidity for a further example of a protective layer.

FIGS. 6a-6e show different configurations of protective layers.

FIG. 7 is a schematic view of an insulated building structure employing protective layers.

### DETAILED DESCRIPTION

The invention is explained below using examples. The hygrothermal simulations described below were carried out with the simulation program WUFI® 5.2. The calculations generally proceed from the most unfavorable conditions. The following basic conditions were considered:
the outer layer covers the entire area (of the roof and/or facade cladding);
the rear ventilation plane has a moisture storage function and an air- and moisture source is assumed;
the roof pitch is 35°, red roofing tiles are assumed, with rain adhesion corresponding to inclination;
for facades, wood cladding is assumed;
the buildings are aligned in the direction of the lowest radiant energy input to simulate the worst case;
calculations were made in two-hour intervals for Sep. 1, 2013 to Sep. 1, 2018;
if multiple records were saved in the climate data, the worst case was used;
an installation plane of 25 mm and a gypsum plasterboard were arranged on the inner side;
the initial moisture content over the component was set at a constant 80%;
the indoor climate was calculated depending on the external air according to EN 15026, with high moisture load.

### EXAMPLE 1

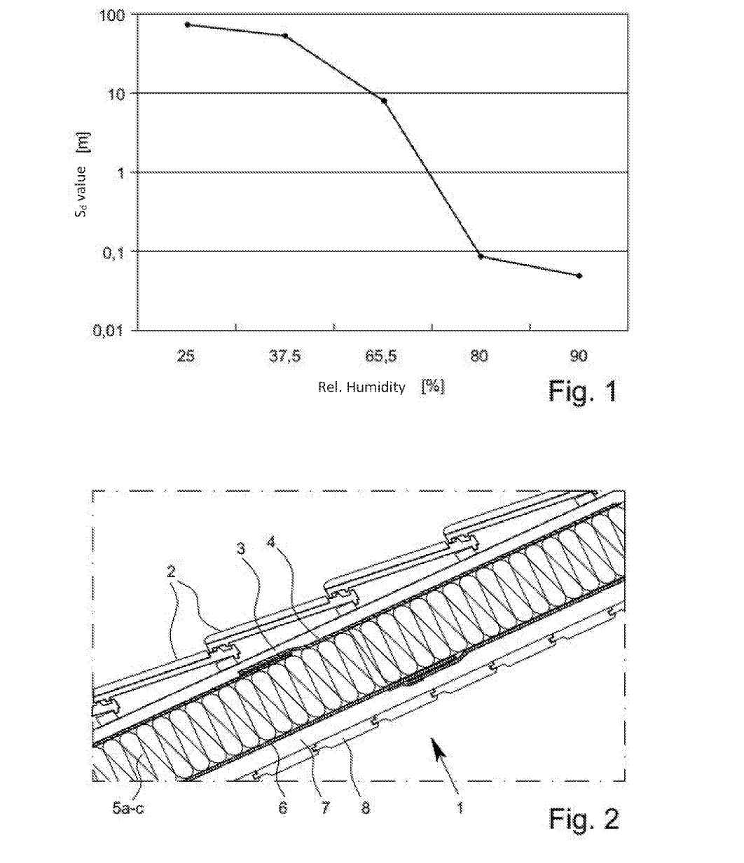

A compound consisting of 60 wt. % of an ether-TPU, brand name DESMOPAN from the Bayer company, and 40 wt. % of an ethylene vinyl alcohol copolymer, brand name EVAL F from the Kuraray company, was poured into a cast film as a protective layer, with a weight per unit area of 100 g/m². FIG. 1 lists the S_{d} values for the protective layer at different relative humidities of the environment. The determination of the water vapor permeability and the measurement of S_{d} values was carried out according to the guidelines of the DIN ISO EN 12572 and 1931.

On the basis of the value pairs of S_{d} values listed in FIG. 1 and determined in experiments with the cast film, and values for the associated relative humidities, hygrothermal simulations were performed to assess the moisture-proofness of a standard pitched roof structure 1. The protective layers 4, 6 according to the invention have the same S_{d} value profile, corresponding to FIG. 1.

The roof structure 1 considered by the hygrothermal simulations is shown schematically in FIG. 2, and has the following construction starting at the outer roof skin:

| Layer/Material | |
|---|---|
| (from outside to inside) | Thickness [m] |
| Roof tile (2) | 0.01 |
| Air layer (3) | 0.025 |
| Protective layer, outside (4) | 0.001 |
| Glass wool layers (5a-c) | 0.140 |
| Protective layer, inside (6) | 0.001 |
| Air layer (7) | 0.025 |
| Gypsum plasterboard (8) | 0.0125 |

WUFI®, 5.2. hygrothermal simulations were performed using the above-mentioned method to calculate the transient heat and moisture transport in components. This same standard pitched roof structure 1 was considered for various climates. WUFI®, 5.2 provides an extensive data collection of diverse climates.

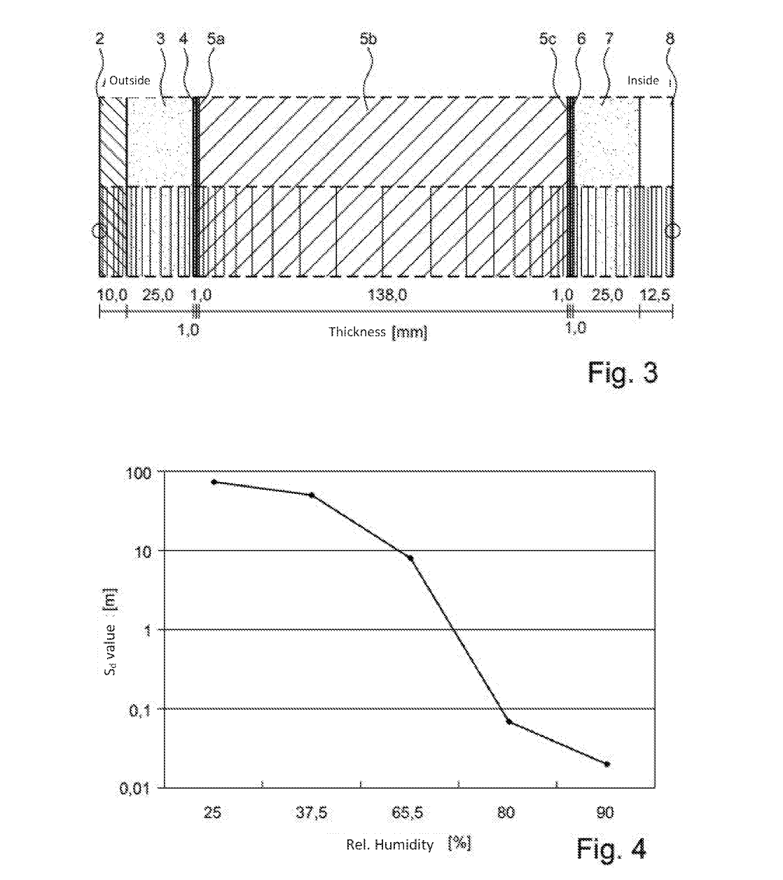

The layer sequence of the pitched roof structure 1 chosen for the simulation, and the layer thicknesses, are shown schematically in FIG. 3. An outer glass wool layer 5a and an inner glass wool layer 5c, each adjacent to one of the protective layers 4, 6, with the thickness of 1 mm were considered, assuming a total thickness of the insulation of 140 mm. The thickness of an average mineral wool layer 5b was therefore 138 mm. It was also assumed that a protective layer 6 according to the invention, which has the proven S_{d} values, is used on the inside, and a further protective layer 4 is used outside the glass wool layers 5a to 5c as the outer layer. The simulation determined the water content of the glass wool layers 5a, 5c directly adjacent to the protective layers 4, 6. The simulation considered climates which represent standard conditions (Holzkirchen), as well as those that reflect extreme conditions (Karasjok, Miami).

The following amounts of water were determined in the glass wool layers 5a, 5c:

| | | | | | Glass wool water | |
|---|---|---|---|---|---|---|
| | | Average | | | content [g/m²] | |
| | | Temperature | | Humidity | Inner | Outer |
| Climate region | Climate type per Neef | [° C.] | | [% ] | side | side |
| Holzkirchen | Transition climate | 6.8 | (−20b32) | 81 | 4 | 26 |
| Miami, USA | Moist trade wind climate | 25 | (6b34) | 71 | 10 | 8 |
| Malaga, Spain | Winter rain climate of the | 18 | (0b40) | 64 | 4 | 10 |
| | west sides | | | | | |
| Karasjok, Norway | (arctic) (sub)polar | −3.1 | (−44b24) | 87 | 2 | 26 |
| Tokyo, Japan | Subtropical east-side climate | 16 | (−1b35) | 62 | 6 | 5 |
| Christchurch, New | Oceanic climate of the west sides | 11 | (−6b34) | 75 | 4 | 13 |
| Zealand | | | | | | |
| Santiago de Chile | | 14 | (0b27) | 62 | 2 | 7 |
| Anchorage, Alaska, USA | | 0.8 | (−30b24) | 71 | 2 | 19 |
| Honolulu warm | Tropical alternating climate | 25 | (16b32) | 65 | 4 | 8 |
| Las Vegas | Dry trade wind climate | 20 | (−8b46) | 25 | 4 | 6 |
| Minneapolis | Cool continental climate | 6 | (−32b35) | 72 | 7 | 32 |
| San Francisco | Winter rains of the west sides | 14 | (2b38) | 71 | 2 | 13 |
| Salt Lake City, USA | High alpine climate | 12 | (−13b38) | 61 | 3 | 14 |
| Colorado Springs | Continental warm summer climate | 8 | (−25b33) | 57 | 2 | 6 |
| Atlantic City | East side climate | 12 | (−21b34) | 71 | 5 | 28 |

### EXAMPLE 2

A fiber mat having a weight per unit area of 70 g/m² was extrusion coated with a compound comprising 65 wt. % of an ether-ester TPU, brand name DESMOPAN from the Bayer company, and 35 wt. % of an ethylene vinyl alcohol copolymer, brand name EVAL C from the Kuraray company, with a weight per unit area of 70 g/m². With the film thus obtained, tests were carried out to determine S_{d} values at different relative humidities.

On the basis of the value pairs of S_{d} values listed in FIG. 4 and determined in experiments with the cast film, and values for the associated relative humidities, hygrothermal simulations were performed to assess the moisture-proofness of the standard pitched roof structure 1 described above. The simulation was performed as described in Example 1. The simulations showed non-critical condensation amounts of well below 100 g/m² for the climates considered. The following amounts of water were determined in the glass wool layers 5a, 5c:

| | | | | | Mineral wool water | |
|---|---|---|---|---|---|---|
| | | Average | | | content [g/m²] | |
| | | Temperature | | Humidity | Inner | Outer |
| Climate region | Climate type per Neef | [° C.] | | [% ] | side | side |
| Holzkirchen | Transition climate | 6.8 | (−20b32) | 81 | 3 | 19 |
| Miami, USA | Moist trade wind climate | 25 | (6b34) | 71 | 6 | 8 |
| Malaga, Spain | Winter rain climate of the | 18 | (0b40) | 64 | 3 | 9 |
| | west sides | | | | | |
| Karasjok, Norway | (arctic) (sub)polar | −3.1 | (−44b24) | 87 | 2 | 15 |
| Tokyo, Japan | Subtropical east-side climate | 16 | (−1b35) | 62 | 4 | 8 |
| Christchurch, New | Oceanic climate of the west sides | 11 | (−6b34) | 75 | 3 | 12 |
| Zealand | | | | | | |
| Santiago de Chile | | 14 | (0b27) | 62 | 2 | 8 |
| Anchorage, Alaska, USA | | 0.8 | (−30b24) | 71 | 2 | 15 |
| Honolulu warm | Tropical alternating climate | 25 | (16b32) | 65 | 3 | 9 |
| Las Vegas | Dry trade wind climate | 20 | (−8b46) | 25 | 2 | 5 |
| Minneapolis | Cool continental climate | 6 | (−32b35) | 72 | 4 | 14 |
| San Francisco | Winter rains of the west sides | 14 | (2b38) | 71 | 2 | 13 |
| Salt Lake City, USA | High alpine climate | 12 | (−13b38) | 61 | 3 | 11 |
| Colorado Springs | Continental warm summer climate | 8 | (−25b33) | 57 | 4 | 13 |
| Atlantic City | East side climate | 12 | (−21b34) | 71 | 3 | 4 |

### EXAMPLE 3

A 41% aqueous polyether polyurethane dispersion from the Alberdingk Boley company was filled with 5 wt. % nanophyllosilicate by means of a ball mill, homogenized and knife-coated onto a PET fleece, having a weight per unit area of 70 g/m², and cross-linked by heat treatment. This produced a film with a weight per unit area of 170 g/m². With the film thus obtained, tests were carried out to determine S_{d} values at different relative humidities.

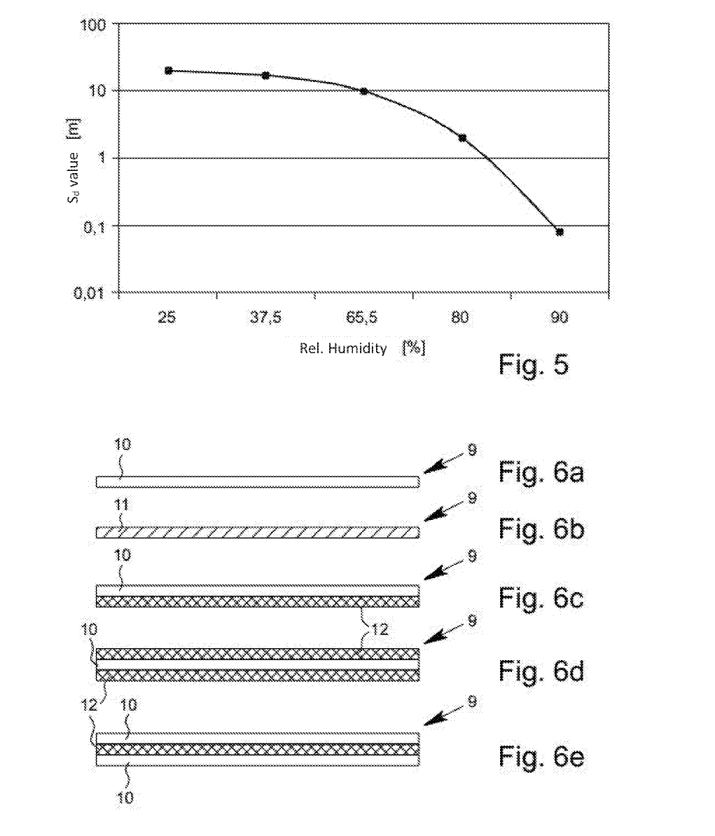

On the basis of the value pairs of S_{d} values listed in FIG. 5 and determined in experiments with the cast film and values for the associated relative humidities, hygrothermal simulations were performed to assess the moisture-proofness of the standard pitched roof structure 1 described above. The simulation was carried out as described above. The simulations showed non-critical condensation amounts of well below 100 g/m² for the climates considered.

In addition, the simulation showed a delayed opening of the film, and/or a delayed lowering of the S_{d} value of the film, upon an increase in moisture. For example, an S_{d} value of 0.07 m was reached at a relative humidity of 90% after about eight hours.

The following amounts of water were determined in the glass wool layers 5a, 5c:

| | | | | | Mineral wool water | |
|---|---|---|---|---|---|---|
| | | Average | | | content [g/m²] | |
| | | Temperature | | Humidity | Inner | Outer |
| Climate region | Climate type per Neef | [° C.] | | [% ] | side | side |
| Holzkirchen | Transition climate | 6.8 | (−20b32) | 81 | 3 | 36 |
| Miami, USA | Moist trade wind climate | 25 | (6b34) | 71 | 6 | 7 |
| Malaga, Spain | Winter rain climate of the | 18 | (0b40) | 64 | 3 | 10 |
| | west sides | | | | | |
| Karasjok, Norway | (arctic) (sub)polar | −3.1 | (−44b24) | 87 | 2 | 120 |
| Tokyo, Japan | Subtropical east-side climate | 16 | (−1b35) | 62 | 6 | 7 |
| Christchurch, New | Oceanic climate of the west sides | 11 | (−6b34) | 75 | 3 | 7 |
| Zealand | | | | | | |
| Santiago de Chile | | 14 | (0b27) | 62 | 2 | 6 |
| Anchorage, Alaska, USA | | 0.8 | (−30b24) | 71 | 2 | 10 |
| Honolulu warm | Tropical alternating climate | 25 | (16b32) | 65 | 3 | 5 |
| Las Vegas | Dry trade wind climate | 20 | (−8b46) | 25 | 4 | 5 |
| Minneapolis | Cool continental climate | 6 | (−32b35) | 72 | 5 | 53 |
| San Francisco | Winter rains of the west sides | 14 | (2b38) | 71 | 2 | 14 |
| Salt Lake City, USA | High alpine climate | 12 | (−13b38) | 61 | 3 | 8 |
| Colorado Springs | Continental warm summer climate | 8 | (−25b33) | 57 | 2 | 13 |
| Atlantic City | East side climate | 12 | (−21b34) | 71 | 4 | 49 |

In the subpolar-arctic climate of Karasjok, this results in a significant increase in the amount of water on the outer protective layer. Although the amount of 120 g /m² is still non-critical, films from Examples 1 or 2 would be more suitable for this climate.

All named value ranges include all intermediate values and intervals, even if they are not explicitly expressed. These intermediate values and intervals are considered essential to the invention. Further features, advantages and details of the invention will become apparent from the following description with reference to the drawings, wherein:

FIGS. 6a-e show different structures of the vapor retarder films according to the invention, and

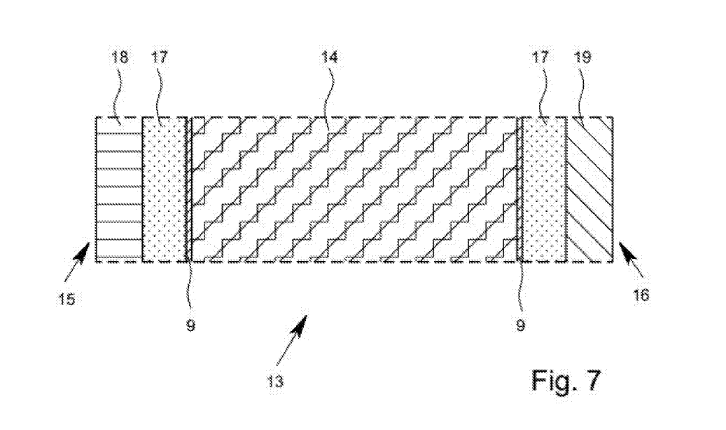

FIG. 7 shows an inventive insulated building structure.

FIGS. 6a to 6e show different configurations of protective layers 9. The protective layers 9 shown have a moisture-adaptive or moisture-variable design, and each have at least one film 10, 11 which has a water vapor diffusion resistance which is dependent on the ambient humidity, and is suitable for use in the structure of buildings due to a sufficient tensile and compressive strength. The protective layer 9 shown in FIG. 6a has a single-layer construction and is formed by the film 10, which can be obtained from a mixture of a polyurethane and an ethylene vinyl alcohol polymer. The protective layer 9 shown in FIG. 6b also comprises a single-layer structure, which is formed by the film 11, wherein the film 11 can be obtained from a polyurethane and has a nanophyllosilicate.

The protective layers 9 shown in FIGS. 6c to 6e each have a multilayer structure with at least one film 10 and with at least one further layer which is formed by a substrate material 12. The substrate material 12 can be a fabric or a fleece. In the protective layer 9 shown in FIG. 6d, the film 10 is arranged between two outer layers of the support material 12. In the protective layer 9 shown in FIG. 6d, the film 10 can be coated on both sides with a woven and/or nonwoven layer. In particular, the film 10 can be laminated on both sides with a woven and/or non-woven layer. In the protective layer 9 shown in FIG. 6e, two outer films 10 are connected to an intermediate layer of the substrate material 12.

It should be understood that in the structures shown in FIGS. 6c to 6e, the film 11 and/or a film which can be obtained from a mixture of a polyurethane and an ethylene vinyl alcohol polymer, and which has a nanophyllosilicate as a filler, can be used in place of the film 10.

FIG. 7 schematically shows an insulated building structure 13, which can be an insulated roof and/or wall structure of a building. The building structure 13 has a thermal insulation layer 14 preferably made of mineral wool. One film, as a protective layer 9, is arranged on an outer side 15 of the thermal insulation layer 14, and another is arranged on an inner side 16 of the thermal insulation layer 14 facing the building interior. Preferably, the same, or identically-constructed, protective layers 9 are arranged on both sides 15, 16 of the thermal insulation layer 14. The protective layers 9 are made of a film or membrane having a water vapor diffusion equivalent air thickness S_{d}, at a relative humidity of the atmosphere surrounding the protective layer 9 in the range from 0 to 25%, of more than 10 m, and having, at a relative humidity of the atmosphere surrounding the protective layer 9 in the range of 90% to 100%, an S_{d} value of less than 0.4 m.

In this way, the barrier values of the protective layer 9 are optimized in such a manner that they can be used both on the outer side 15 and on the inner side 16 of the thermal insulation layer 14. An air layer 17 contacts the protective layers 9 on each side 15, 16 of the thermal insulation layer 14. A cladding 18 forms the outermost layer, which can be a roofing made of tiles or the like, or a facade cladding, and the cladding 19 forms the innermost layer, which can be a gypsum plasterboard wall or another conventional internal cladding.

The building structure 13 can have a layer sequence and/or layer thicknesses that deviates from the sequence of layers and the layer thicknesses shown in FIG. 7. Only the position of the protective layer 9 according to the invention directly on the outer and/or inner side 15, 16 of the thermal insulation layer 14 is fixed.

### LIST OF REFERENCE NUMBERS

1 Roof structure
2 Roof tile
3 Air layer
4 Protective layer
5a to c Glass wool layers
6 Protective layer
7 Air layer
8 Gypsum plasterboard
9 Protective layer
10 Film
11 Film
12 Substrate material
13 Building structure
14 Thermal insulation layer
15 Outer side
16 Inner side
17 Air layer
18 Cladding
19 Cladding

1. A moisture-variable protective layer, particularly for use in protecting a thermal insulation layer in an insulated building comprising a water vapor diffusion equivalent air layer thickness S_{d} that depends on the ambient moisture, wherein the protective layer comprises a material, which has a water vapor diffusion equivalent air layer thickness S_{d} of greater than 10 m at a relative humidity of the atmosphere surrounding the protective layer in the range from 0% to 25%, and has a water vapor diffusion equivalent air layer thickness S_{d} of less than 0.4 m at a relative humidity of the atmosphere surrounding the protective layer in the range from 90% to 100%.

2. The protective layer according to claim 1, wherein the S_{d} value, at a relative humidity of 25%, is between 20 m and 100 m, the S_{d} value, at a relative humidity of 37.5%, is between 20 m and 90 m, the S_{d} value, at a relative humidity of 65.5%, is between 4 m and 20 m, the S_{d} value, at a relative humidity of 80%, is between 0.07 m and 0.1 m, and the S_{d} value, at a relative humidity of 90%, is less than 0.09 m.

3. The protective layer according to claim 1, wherein the S_{d} value, at a relative humidity of 25%, is between 10 m and 30 m, the S_{d} value, at a relative humidity of 37.5%, is between 10 m and 30 m, but is less than at a relative humidity of 25%, the S_{d} value, at a relative humidity of 65.5%, is between 5 m and 15 m, but is less than at a relative humidity of 37.5%, the S_{d} value, at a relative humidity of 80%, is between 0.8 m and 5 m, and the S_{d} value, at a relative humidity of 90%, is between 0.08 m and 0.12 m.

4. The protective layer according to claim 1, wherein the material is configured as a flat structure, formed as a film or as a coating of a substrate material.

5. The protective layer according to claim 1, wherein the material comprises at least one of a polyamide and a polyamide copolymer.

6. The protective layer according to claim 1, wherein the material comprises an ionomer.

7. The protective layer according to claim 1, wherein the material is an ethylene vinyl alcohol homo- or copolymer.

8. The protective layer according to claim 1, wherein the material is a polyurethane.

9. The protective layer according to claim 1, wherein the material comprises an ethylene vinyl acetate.

10. The protective layer according to claim 1, wherein a change in the relative humidity of the atmosphere surrounding the protective layer leads to a delayed change in the water vapor diffusion equivalent air layer thickness S_{d} of the material.

11. The protective layer according to claim 1, wherein at least one moisture-variable protective layer is provided on an outer side of the thermal insulation layer or on an inner side of the thermal insulation layer facing an interior of the insulated building.

12. The protective layer according to claim 1, wherein at least one moisture-variable protective layer is provided on an outer side of the thermal insulation layer and on an inner side of the thermal insulation layer facing an interior of the insulated building.

13. The protective layer according to claim 1, wherein the protective layer is provided on the outer side of the thermal insulation layer and on the inner side of the thermal insulation layer.

14. The protective layer according to claim 13, wherein the water vapor diffusion equivalent air layer thicknesses S_{d} of both protective layers deviate from each other by less than 20%, preferably less than 10%, in the range of a relative humidity from 0% to 25% or in the range of a relative humidity from 80% to 100%.

15. The protective layer according to claim 13, wherein the water vapor diffusion equivalent air layer thicknesses S_{d} of both protective layers deviate from each other by less than 20%, preferably less than 10%, in the range of a relative humidity from 0% to 25% and in the range of a relative humidity from 80% to 100%.

16. The protective layer according to claim 1, wherein the S_{d} value, at a relative humidity of 25%, is between 40 m and 90 m, the S_{d} value, at a relative humidity of 37.5%, is between 30 m and 80 m, the S_{d} value, at a relative humidity of 65.5%, is between 5 m and 15 m and the S_{d} value, at a relative humidity of 80%, is less than 0.1 m.

17. The protective layer according to claim 3, wherein the S_{d} value, at the relative humidity of 80%, is between 1 m and 3 m.

18. The protective layer according to claim 4, wherein the coating is configured as a spray coating.

19. The protective layer according to claim 5, wherein the polyamide is PA 6 or PA 3.

20. The protective layer according to claim 10, wherein an increase in the relative humidity leads to a lowering of the water vapor diffusion equivalent air layer thickness S_{d} of the material after 2 h to 96 h.
